(19) United States
(12) Patent Application Publication
(10) Pub. No.: US 2024/0153414 A1
(43) Pub. Date: May 9, 2024

(54) Body-Worn Water Sports Safety Flag Device

(71) Applicants: Patricia Dionne, Key Largo, FL (US); Rachel Dionne, Key Largo, FL (US); Rissa Dionne, Key Largo, FL (US)

(72) Inventors: Patricia Dionne, Key Largo, FL (US); Rachel Dionne, Key Largo, FL (US); Rissa Dionne, Key Largo, FL (US)

(21) Appl. No.: 18/502,170

(22) Filed: Nov. 6, 2023

Related U.S. Application Data
(60) Provisional application No. 63/422,941, filed on Nov. 5, 2022.

(51) Int. Cl. G09F 17/00; B63C 9/00; G10K 5/00

(52) U.S. Cl. CPC G09F 17/00; B63C 9/00; G10K 5/00; G09F 2017/0083

(57) ABSTRACT

A body-worn water sports safety flag device is provided. The device is comprised of a body, a whistle, and a flag and may be worn when a person is performing a water sports activity. The body is made of a waterproof plastic material and is preferably made from a bright or reflective color such that the device is easily identifiable. A flag may be pulled from a pocket of the body if a user falls into the water to provide a visual cue to passengers of boats. Additionally, a whistle may be blown to provide an audio cue to the location of the user.

### CROSS-REFERENCE TO RELATED APPLICATION

The present application claims priority to, and the benefit of, U.S. Provisional Application No. 63/422,941, which was filed on Nov. 5, 2022, and is incorporated herein by reference in its entirety.

### FIELD OF THE INVENTION

The present invention relates generally to the field of water sports. More specifically, the present invention relates to a body-worn water sports safety flag device comprised of a body, a whistle, and a flag and may be worn when a person is performing a water sports activity wherein the flag may be pulled from a pocket of the body if a user falls into the water to provide a visual cue to passengers of boats. Accordingly, the present disclosure makes specific reference thereto. Nonetheless, it is to be appreciated that aspects of the present invention are also equally applicable to other like applications, devices, and methods of manufacture.

### BACKGROUND

Floatation devices, commonly worn by individuals as a safety measure when participating in water-based activities, play a crucial role in preventing drownings and saving lives. Such devices are especially important for activities that involve being in deeper water, far from the shore, or in areas with fast currents. However, there are situations where simply wearing a flotation device may not be enough to ensure a person's safety. For instance, in locations where there is a high density of boats or other watercraft, an individual who falls into the water may be at risk of not being seen or quickly rescued, even if they are wearing a flotation device. The likelihood of this happening increases when the water is rough, the tide is strong, or the visibility is poor due to weather conditions. In such cases, the risk of collisions with other vessels becomes a significant concern, and the chances of the individual suffering serious injuries or even fatalities are considerably heightened.

Moreover, when a person is in the water and in distress, their options for alerting others to their presence and need for assistance are severely limited. Beyond splashing and attempting to wave their arms, they may have no other way to signal for help, especially if they are too far away for their voice to be heard. In some cases, they may be unable to perform any of these actions due to injury, exhaustion, or panic. Consequently, the effectiveness of traditional flotation devices in such situations is undermined by their inability to facilitate the swift identification and location of the person in need of rescue.

Therefore, there exists a long-felt need in the art for a device that allows a person within a body of water to remain visible to other individuals and vessels. There also exists a long-felt need in the art for a body-worn watersports safety flag device that can be used to increase the visibility of an individual within a body of water in order to allow the individual to be picked up or rescued. In addition, there exists a long-felt need in the art for a body-worn watersports safety flag device that can be worn by any individual.

The subject matter disclosed and claimed herein, in one embodiment thereof, comprises a body-worn water sports safety flag device. The device is comprised of a body, a whistle, and a flag. The device may be worn when an individual is performing a water sports activity such as, but not limited to, tubing, water skiing, jet skiing, boating, etc. The body is made of a waterproof plastic material and is preferably made from a bright or reflective color such that the device is easily identifiable. When a person falls into the water, a flag may be pulled from a pocket of the body and a whistle may be blown, providing both auditory and visual cues of the location of the user to passengers of their boat or water vessel and passengers of other boats or water vessels.

In this manner, the body-worn water sports safety flag device of the present invention accomplishes all the foregoing objectives and provides a device that allows a person who has fallen from a water vessel into the water to be easily spotted. More specifically, the body-worn water sports safety flag device can alert passengers on water vessels that a user has fallen into the water by both visual and auditory alerts. Furthermore, the device can be worn by any person.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a body-worn water sports safety flag device primarily comprised of a body, a whistle, and a flag. The device is designed to be worn by someone performing a water sport such that if the person falls into the water, the person can remain visible and be easily spotted by the passengers of the boats and by passengers of other boats or water vessels.

The device is comprised of a hollow, generally cylindrical body made of a flexible plastic. The body may be made of a bright or reflective color that is easily identifiable. The body is further comprised of a whistle and a flag opening. The whistle may be blown by the user to produce a sound that could help others locate the position of the user in the water. In one potential embodiment, at least one fastener may be used to further secure the device to the arm of a user. The flag opening may allow a user to access a flag inside of a pocket of the body.

The pocket of the body may be further comprised of a button that may lock the flag inside of the pocket. By pressing the button, the flag may unlock, allowing a user to pull the flag from the pocket. The flag may further be attached to a roller inside of the pocket that allows the flag to be easily removed from and retracted back into the pocket. In one potential embodiment, the button may be used to lock the length of the flag out of the pocket such that the full length of the flag may be removed from the pocket, creating maximum visibility of the flag.

The present invention is also comprised of a method of using the device. First, a device is provided comprised of a body, a whistle, and a flag. Then, the body may be attached to the arm or wrist of a user by compressing around the user. Then, when the user falls into the water, the button of the pocket may be pressed and the flag may be pulled from the pocket to a length desired by the user. Next, the user may pull the flag slightly further to activate the roller to retract the flag back into the pocket of the body.

The present invention is also comprised of a second method of using the device. First, a device is provided comprised of a body, a whistle, and a flag. Then, the body may be placed around the arm or wrist of a user and secured to the arm or wrist of the user via at least one fastener. Then, when the user falls into the water, the button of the pocket may be pressed and the flag may be pulled from the pocket to a length desired by the user. Next, the user may pull the flag slightly further to activate the roller to retract the flag back into the pocket of the body.

Accordingly, the body-worn water sports safety flag device of the present invention is particularly advantageous as it provides a device that allows a person who has fallen from a water vessel into the water to be easily spotted. More specifically, the body-worn sports safety flag device may be worn by any person of any size. Furthermore, the body-worn water sports safety flag device may alert passengers of boats or other water vessels of a user who has fallen into the water with both visual and auditory cues. In this manner, the body-worn water sports safety flag device provides a solution to enjoying water sports safely.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a body-worn water sports safety flag device of the present invention with the flag not extended from the body in accordance with the disclosed architecture;

FIG. 2 illustrates a perspective view of one potential embodiment of a body-worn water sports safety flag device of the present invention with the flag extended from the body in accordance with the disclosed architecture;

FIG. 3 illustrates a perspective view of one potential embodiment of a body-worn water sports safety flag device of the present invention with the flag extended from the body and wherein the device is worn around an arm of a user in accordance with the disclosed architecture;

FIG. 4 illustrates a flowchart of a method of using one potential embodiment of a body-worn water sports safety flag device of the present invention in accordance with the disclosed architecture; and

FIG. 5 illustrates a flowchart of a method of using one potential embodiment of a body-worn water sports safety flag device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that allows a person within a body of water to remain visible to other individuals and vessels. There also exists a long-felt need in the art for a body-worn watersports safety flag device that can be used to increase the visibility of an individual within a body of water in order to allow the individual to be picked up or rescued. In addition, there exists a long-felt need in the art for a body-worn watersports safety flag device that can be worn by any individual.

The present invention, in one exemplary embodiment, is comprised of a body-worn water sports safety flag device. The device is primarily comprised of a body, a whistle, and a flag. The device is designed to be worn by someone performing a water sport such that if the person falls into the water, the person can remain visible and be easily spotted by the passengers of the boats and by passengers of other boats or water vessels.

More specifically, the device is comprised of a generally cylindrical body that is comprised of an opening to make the body hollow. The body is preferably made from a flexible plastic or reflective material such that it is waterproof and may be of a bright or reflective color. The body is further comprised of a marker, a whistle, and a flag opening. The body of the device may be attached to an arm or other extremity of a user and the marker may be used to identify the user if multiple users are using differing instances of the device. In one potential embodiment, the body may be comprised of at least one fastener that allows the device to be secured around the arm of the user. The whistle may be blown into by the user, creating a sound that may notify passengers of water vessels of the location of the user. The flag opening may allow a user to access a flag stored inside a pocket of the body.

The pocket of the body may store a flag. The pocket may be further comprised of a button and a cutout. In one potential embodiment, the button may lock the flag inside the pocket, such that the flag may not accidentally extend out through the flag opening during a water sport or other activity. By pressing the button, the locking mechanism may be lifted and the flag may be removed from the pocket. The cutout of the pocket allows for the user to easily grip the end of the flag when attempting to pull the flag out of the pocket. The end of the flag may be made from a heavier material to allow the flag to easily blow in the wind and expand.

The flag may be easily pulled from the pocket and placed back into the pocket by attaching to a roller inside of the pocket of the body. In one potential embodiment, the roller may be spring-loaded, such that the flag may be easily retracted back into the pocket. In this embodiment, the roller may lock when the flag is pulled to a length desired by the user. By pulling on the flag further, the lock may be disabled to allow the spring of the roller to easily retract back into the pocket of the body. In another potential embodiment, the button of the pocket may be used to lock the flag. By pressing the button, the length of the flag may be fixed. Then by releasing the button, the roller may pull the flag back into the pocket of the body.

The present invention is also comprised of a method of using the device. First, a device is provided comprised of a body, a whistle, and a flag. Then, the body may be attached to the arm or wrist of a user by compressing around the user. Then, when the user falls into the water, the button of the pocket may be pressed and the flag may be pulled from the pocket to a length desired by the user. Next, the user may pull the flag slightly further to activate the roller to retract the flag back into the pocket of the body.

The present invention is also comprised of a second method of using the device. First, a device is provided comprised of a body, a whistle, and a flag. Then, the body may be placed around the arm or wrist of a user and secured to the arm or wrist of the user via at least one fastener. Then, when the user falls into the water, the button of the pocket may be pressed and the flag may be pulled from the pocket to a length desired by the user. Next, the user may pull the flag slightly further to activate the roller to retract the flag back into the pocket of the body.

Accordingly, the body-worn water sports safety flag device of the present invention is particularly advantageous as it provides a device that allows a person who has fallen from a water vessel into the water to be easily spotted. More specifically, the body-worn sports safety flag device may use both audio and visual cues to alert passengers of boats or other water vessels of the location of a user of the device who has fallen into the water. Furthermore, the body-worn water sports safety flag device may be worn by any person of any size when near the water or performing a water sport. In this manner, the body-worn water sports safety flag device provides a solution to enjoying water sports safely.

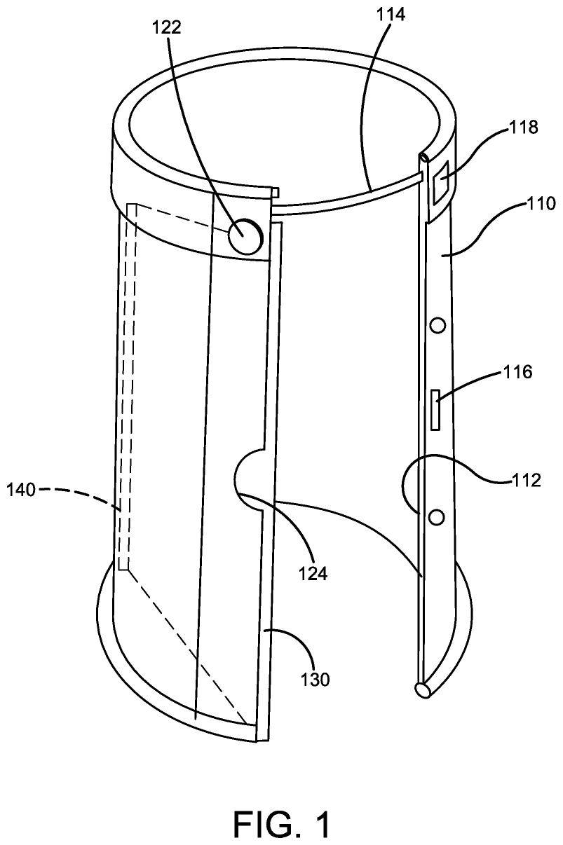

Referring initially to the drawings, FIG. 1 illustrates a perspective view of one potential embodiment of a body-worn water sports safety flag device 100 of the present invention with the flag 130 not extended from the body 110 in accordance with the disclosed architecture. The device 100 is primarily comprised of a body 110, at least one whistle 118, and at least one flag 130. The device 100 is designed to be worn by someone performing a water sport (or any activity on/in water) such that if the person falls into the water, the person can remain visible and be easily spotted by the passengers of the water vessel and by passengers of other boats or water vessels for rescue.

The device 100 is comprised of a generally cylindrical and hollow body 110 that is wide enough to fit around the arm or other extremity of a human body via at least one opening 112. However, in another embodiment, the body 110 may have no opening 112. The body 110 is preferably made from a flexible plastic material such that it is waterproof and may stretch to fit around any arm of any size. In one potential embodiment, the body 110 may be comprised of at least one fastener 114 to better secure the device 100 to the arm (or other extremity) of the user. The fastener 114 may be any fastener known in the art such as, but not limited to, a strap, a hook-and-loop fastener, an elastic band, a hook and eyelet, etc. The body 110 may further be made of a bright or reflective color such that the person wearing the device 100 may be easily spotted by nearby individuals.

The body 110 is further comprised of at least one marker 116, a whistle 118, and a flag opening 119. The marker 116 may be used to identify a specific user when multiple instances of the device 100 are being worn by multiple different users. The marker 116 may be any letter, number, color, symbol, indicia, etc., on the surface of the body 110. The marker 116 may also be reflective for further visibility.

After a user falls into a body of water, the whistle 118 may be blown into by the user, producing a sound to provide others with an audio cue that may be used to further locate the user in the water. The whistle 118 may be any type known in the art.

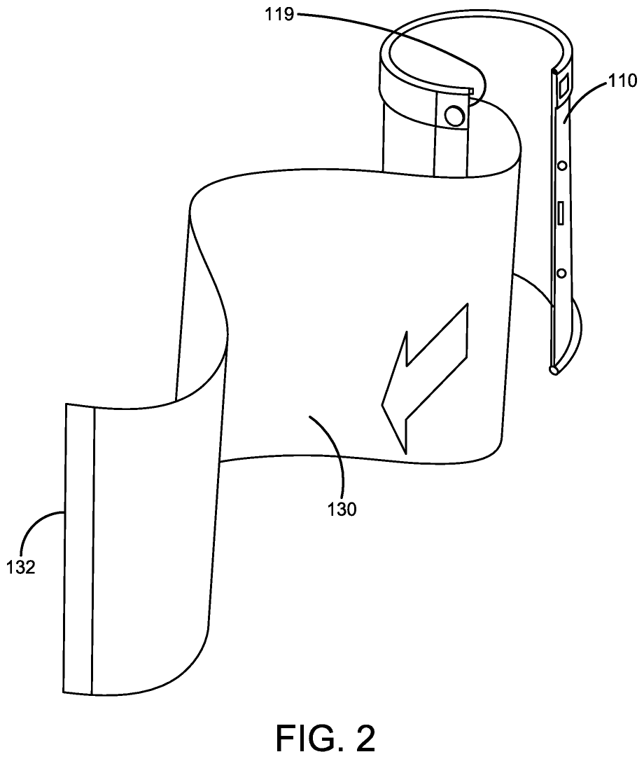

FIG. 2 illustrates a perspective view of one potential embodiment of a body-worn water sports safety flag device 100 of the present invention with the flag 130 extended from the body 110 in accordance with the disclosed architecture. The pocket 120 may store a flag 130 that may be pulled out of the pocket 120 to provide a visual cue that may be used to locate the user in the water as a user waves their arm above their head. The pocket 120 may be further comprised of at least one button 122 and at least one cutout 124. In one potential embodiment, the button 122 may lock the flag 130 inside of the pocket 120. Once the button 122 is pressed, the lock may be disabled, allowing the user to pull the flag 130 from the pocket 120. The cutout 124 may provide a point of contact from which the user may grip an end 132 of the flag 130 to pull the flag 130 out of the pocket 120. The flag 130 may be comprised of an end 132 that is made of a heavier material to allow the flag 130 to blow in the wind, expanding for maximum visibility. In one embodiment, the pocket 120 may be positioned on the exterior of the body 110.

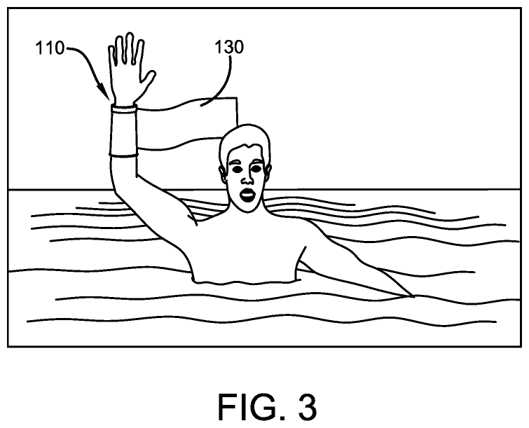

FIG. 3 illustrates a perspective view of one potential embodiment of a body-worn water sports safety flag device 100 of the present invention with the flag 130 extended from the body 110 and wherein the device 100 is worn around an arm of a user in accordance with the disclosed architecture. The flag 130 may be attached to at least one roller 140 (or other similar mechanism) inside of the pocket 120 of the body 110. The roller 140 may allow for the flag 130 to easily be retracted back into the pocket 120 when not in use. In one potential embodiment, the roller 140 may be spring-loaded such that when the flag 130 is pulled to full length the flag 130 is locked at that position and length. By pulling on the flag 130 further, the roller 140 may unlock, pulling the flag 130 back into the pocket 120 around the roller 140. In another potential embodiment, the button 122 of the pocket 120 may be used to lock the length of the flag 130 out of the pocket 120. Once the flag 130 is pulled to a desired length out of the pocket 120, the button 122 may be pressed to lock the flag 130 at the desired length. The button 122 may be deactivated to unlock the flag 130, allowing the flag 130 to retract back into the pocket 120.

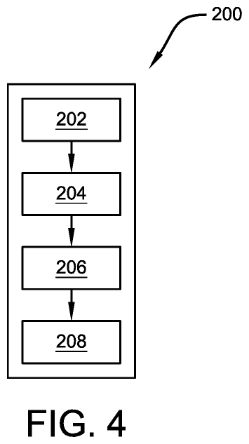

The present invention is also comprised of a method 200 of using the device 100, as seen in FIG. 4. First, a device 100 is provided comprised of a body 110, at least one whistle 118, and at least one flag 130 [Step 202]. Then, the body 110 may be attached to the arm (or other extremity) of a user by placing the body 110 around the arm [Step 204]. Then, when the user falls into water, the button 122 of the pocket 120 may be pressed by the user and the flag 130 may be pulled from the pocket 120 to a length desired by the user such that a user can wave their arm with the flag 130 extended from the pocket 120 [Step 206]. Next, the user may pull the flag 130 slightly further to activate the roller 140 to retract the flag 130 back into the pocket 120 of the body 110 once rescued [Step 208].

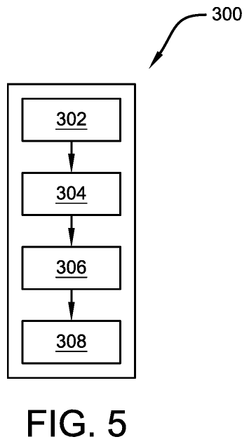

The present invention is also comprised of a second method 300 of using the device 100, as seen in FIG. 5. First, a device 100 is provided comprised of a body 110, at least one whistle 118, and at least one flag 130 [Step 302]. Then, the body 110 may be placed around the arm (or other extremity) of a user and secured to/around the arm via at least one fastener 114 [Step 304]. Then, when the user falls into the water, the button 122 of the pocket 120 may be pressed and the flag 130 may be pulled from the pocket 120 to a length desired by the user such that a user can wave their arm with the flag extended from the pocket 120 [Step 306]. Next, the user may pull the flag 130 slightly further to activate the roller 140 to retract the flag 130 back into the pocket 120 of the body 110 once rescued [Step 308].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “body-worn water sports safety flag device” and “device” are interchangeable and refer to the body-worn water sports safety flag device 100 of the present invention.

Notwithstanding the foregoing, the body-worn water sports safety flag device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the body-worn water sports safety flag device 100 as shown in the FIGS. are for illustrative purposes only, and that many other sizes and shapes of the body-worn water sports safety flag device 100 are well within the scope of the present disclosure. Although the dimensions of the body-worn water sports safety flag device 100 are important design parameters for user convenience, the body-worn water sports safety flag device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A body-worn water sports safety flag device comprising:
a hollow body;
a flag positioned within a pocket of the hollow body; and
a whistle positioned on the hollow body.

2. The body-worn water sports safety flag device of claim 1, wherein the hollow body is reflective.

3. The body-worn water sports safety flag device of claim 1, wherein the flag is reflective.

4. The body-worn water sports safety flag device of claim 1 comprised of a marker.

5. The body-worn water sports safety flag device of claim 4, wherein the marker is comprised of a letter, a number, a symbol, a color, or an indicia.

6. The body-worn water sports safety flag device of claim 1, wherein the marker is reflective.

7. The body-worn water sports safety flag device of claim 1, wherein the body is comprised of a flexible plastic.

8. The body-worn water sports safety flag device of claim 1, wherein the pocket is positioned on an exterior of the body.

9. A body-worn water sports safety flag device comprising:
a hollow body comprised of an opening;
a flag positioned within a pocket positioned within the hollow body; and
a whistle positioned on the hollow body.

10. The body-worn water sports safety flag device of claim 9, wherein the hollow body is comprised of a fastener.

11. The body-worn water sports safety flag device of claim 10, wherein the fastener is comprised of a strap, a hook and loop fastener, an elastic band, or a hook and eyelet fastener.

12. The body-worn water sports safety flag device of claim 9 further comprised of a roller positioned within the hollow body.

13. The body-worn water sports safety flag device of claim 12, wherein the roller is comprised of a spring loaded roller.

14. The body-worn water sports safety flag device of claim 12, wherein the flag attaches to the roller.

15. The body-worn water sports safety flag device of claim 9 further comprised of a button.

16. The body-worn water sports safety flag device of claim 15, wherein the button locks the flag within the hollow body.

17. The body-worn water sports safety flag device of claim 9, wherein the hollow body is comprised of a flag opening.

18. A method of using an body-worn water sports safety flag device, the method comprising the following steps:
providing a body-worn water sports safety flag device comprised of a body, a flag, and a whistle;
attaching the body around an extremity;
pulling the flag from the body after falling into a body of water;
waving the extremity with the flag extended from the body; and
blowing into the whistle.

19. The method of using a body-worn water sports safety flag device of claim 18 further comprised of a step of retracting the flag back into the body.

20. The method of using a body-worn water sports safety flag device of claim 18 further comprised of a step of pressing a button to allow the flag to be pulled from the body.
